(19) United States
(12) Patent Application Publication
(10) Pub. No.: US 2020/0348932 A1
(43) Pub. Date: Nov. 5, 2020

(54) MEMORY CONTROL SYSTEM WITH A SEQUENCE PROCESSING UNIT

(71) Applicant: Yangtze Memory Technologies Co., Ltd., wuhan City (CN)

(72) Inventors: Huang Peng Zhang, Wuhan City (CN); XIANG FU, Wuhan City (CN); Qi Wang, Wuhan City (CN); Zhi Chao Du, Wuhan City (CN); Hua Min Cao, Wuhan City (CN); Xin Yun Huang, Wuhan City (CN); Wen Wen Dong, Wuhan City (CN); Shu Bing Xu, Wuhan City (CN)

(21) Appl. No.: 16/441,021

(22) Filed: Jun. 14, 2019

Related U.S. Application Data
(63) Continuation of application No. PCT/CN2019/085504, filed on May 5, 2019.

(51) Int. Cl. G06F 9/22; G06F 9/448; G06F 13/16; G06F 3/06

(52) U.S. Cl. CPC G06F 9/223; G06F 9/4498; G06F 3/0673; G06F 3/0604; G06F 3/0659; G06F 13/1668

(57) ABSTRACT

A memory control system includes a memory interface, a microcontroller, and a sequence processing unit. The memory interface circuit receives a memory operation command and generates a plurality of operation instructions according to the memory operation command. The microcontroller is coupled to the memory interface circuit . The microcontroller receives the plurality of operation instructions and generates a plurality of task instructions according a scheduling algorithm through a predetermined protocol. The sequence processing unit is coupled to the microcontroller. The sequence processing unit receives the plurality of task instructions through the predetermined protocol, and controls a plurality of circuits of a memory device according to the plurality of task instructions with at least one finite state machine of the sequence processing unit.

### CROSS REFERENCE TO RELATED APPLICATIONS

This application is a continuation of PCT Application No. PCT/CN2019/085504 filed on May 5, 2019, the entire contents of which are incorporated herein by reference.

### BACKGROUND OF THE INVENTION

### 1. Field of the Invention

The present invention is related to a memory control system, and more particularly, to a memory control system with a sequence processing unit.

### 2. Description of the Prior Art

Since the memory operations, such as program operations and read operations, usually involve complicate signal control and address decoding, the memories are usually accessed through internal memory control architectures. The traditional memory control architecture is usually based on microcontrollers to handle complicate controls, such as the control of the charge pump, the power regulator, the address decoder, and the sense amplifier.

However, due to the regular processing procedures, for example, the cycle of fetching, decoding and executing, required by microcontroller, the resource utilization ratio and the performance of the microcontroller are rather low. Furthermore, since the development of memory control is based on operation instructions that are not intuitively readable, it is difficult to maintain or update.

### SUMMARY OF THE INVENTION

One embodiment of the present invention discloses a memory control system. The memory control system includes a memory interface circuit, a microcontroller, and a sequence processing unit.

The memory interface circuit receives a memory operation command, and generates a plurality of operation instructions according to the memory operation command. The microcontroller is coupled to the memory interface circuit. The microcontroller receives the plurality of operation instructions, and generates a plurality of task instructions according a scheduling algorithm through a predetermined protocol. The sequence processing unit is coupled to the microcontroller, and includes at least one finite state machine. The sequence processing unit receives the plurality of task instructions through the predetermined protocol, and controls a plurality of circuits of a memory device according to the plurality of task instructions with the at least one finite state machine.

Another embodiment of the present invention discloses a method for operating a memory control system. The memory control system includes a memory interface circuit, a microcontroller, and a sequence processing unit. The sequence processing unit includes at least one finite state machine.

The method includes the memory interface circuit generating a plurality of operation instructions according to a memory operation command, the microcontroller receiving the plurality of operation instructions, the microcontroller issuing a plurality of task instructions according a scheduling algorithm through a predetermined protocol, the sequence processing unit receiving the plurality of task instructions through the predetermined protocol, and the sequence processing unit controlling a plurality of circuits of a memory device according to the plurality of task instructions with the at least one finite state machine.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a memory control system according to one embodiment of the present invention.

FIG. 2 shows the timing diagram of the communication between the micro controller and the sequence processing unit.

FIG. 3 shows the task instruction set stored in the internal storage unit according to one scheduling algorithm.

FIG. 4 shows the task instruction set stored in the internal storage unit according to another scheduling algorithm.

FIG. 5 shows a method for operating the memory control system in FIG. 1 according to one embodiment of the present invention.

### DETAILED DESCRIPTION

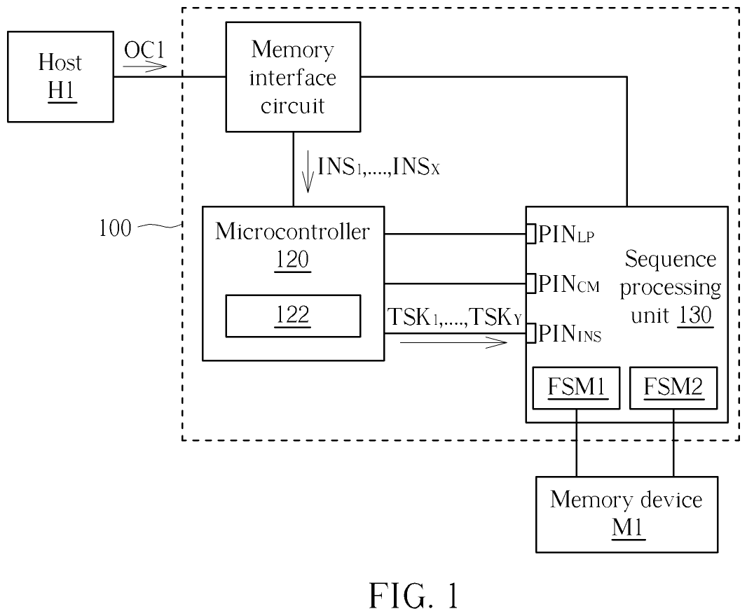

FIG. 1 shows a memory control system 100 according to one embodiment of the present invention. The memory control system 100 includes a memory interface circuit 110, a microcontroller 120, and a sequence processing unit 130. In FIG. 1, the memory control system 100 can be used to assist the host H1 to access the memory device M1 so the host H1 can control the memory device M1 with simple operations. In some embodiments, the memory interface circuit 110, the microcontroller 120, and the sequence processing unit 130 can be disposed in the same chip.

The memory interface circuit 110 can receive the memory operation command OC1. In some embodiments, the memory operation command OC1 can be a relatively high level command generated by the host H1, such as the central processing unit of the computer system, for controlling the memory device M1. The memory interface circuit 110 can decode the memory operation command OC1 and generate a plurality of operation instructions INS₁ to INS_{X} to trigger the microcontroller 120 according to the memory operation command OC1, where X is a positive integer.

In some embodiments, the memory interface circuit 110 and the microcontroller 120 may communicate through a standard bus protocol, for example but not limited to system management bus or inter-integrated circuit bus. In this case, the memory interface circuit 110 may generate the operation instructions INS₁ to INS_{X} by reforming the memory operation command OC1 to comply with the bus protocol in use.

The microcontroller 120 is coupled to the memory interface circuit 110. The microcontroller 120 can receive the plurality of operation instructions INS₁ to INS_{X}, and generate a plurality of task instructions TSK₁ to TSK_{Y} according the scheduling algorithm, where Y is a positive integer.

The sequence processing unit 130 is coupled to the microcontroller 120, and includes finite state machines FSM1 and FSM2. The sequence processing unit 130 can receive the task instructions TSK₁ to TSK_{Y}, and control the circuits of a memory device M1 according to the task instructions TSK₁ to TSK_{Y} with the finite state machines FSM1 and FSM2.

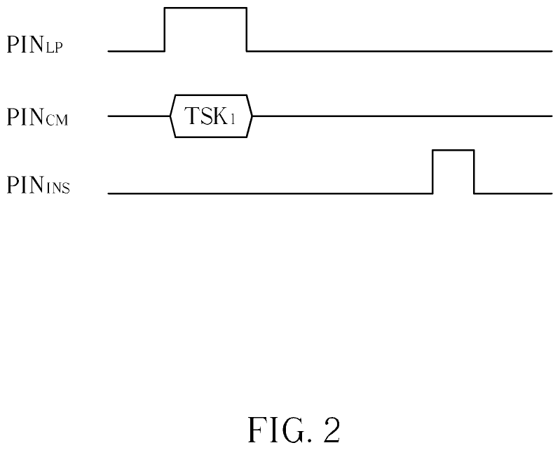

In some embodiments, the microcontroller 120 and the sequence processing unit 130 can communicate through a predetermined protocol. For example, the sequence processing unit 130 can further include a load pin PIN_{LD}, an operation instruction pin PIN_{INS}, and a completion pin PIN_{CM}. FIG. 2 shows the timing diagram of the communication between the micro controller 120 and the sequence processing unit 130.

In FIG. 2, the microcontroller 120 can raise the voltage of the load pin PIN_{LD} to indicate that the coming task instruction TSK₁ is valid. Therefore, the sequence processing unit 130 will receive the task instruction TSK₁ when the voltage of the load pin PIN_{LD} is pulled high by the microcontroller 120.

Furthermore, after the task instruction TSK₁ has been executed, the sequence processing unit 130 can raise the voltage of the completion pin PIN_{CM} to notify the microcontroller 120. However, in some other embodiments, the microcontroller 120 and the sequence processing unit 130 may communicate with a different scheme and/or with different pins according to the system requirement.

In some embodiments, the sequence processing unit 130 may control the circuits of the memory device M1, such as the power regulator for providing the required word line voltages, the address decoder for selecting the target memory cell, and/or the sense amplifier for sensing the read currents. Furthermore, in some embodiments, the memory device M1 can be a non-volatile memory (NVM). Since the non-volatile memory may need a high program voltage for the program operation, the sequence processing unit 130 may also control the charge pump for providing the high program voltages.

In addition, in some embodiments, the sequence processing unit 130 may use different finite state machines to handle different types of circuits. For example, the finite state machine FSM1 may be used to control circuits related to the core voltages while the finite state machine FSM2 may be used to control the circuits related to the page buffer. However, in some other embodiments, the sequence processing unit 130 may include more or less finite state machines for controlling the circuits of the memory device 100 according to the system requirement.

Since the sequence processing unit 130 can control the memory device M1 with the finite state machines FSM1 and FSM2, the control operation can be performed in a more straight forward manner without redundant routine operations required by the microcontroller used in prior art. Therefore, the resource utilization ratio and the performance of the sequence processing unit 130 can be improved.

While the sequence processing unit 130 can control the circuits of the memory device 100 directly, the microcontroller 120 can control the schedule of the tasks performed by the sequence processing unit 130. That is, the microcontroller 120 can assign the task instructions TSK₁ to TSK_{Y} with a desired order according to the scheduling algorithm. In some embodiments, the task instructions can be stored as a set with the desired order in an internal storage unit 122 of the microcontroller 120, and the microcontroller 120 can issue the task instructions with the predetermined order corresponding to the operation instruction transmitted from the memory interface circuit 110.

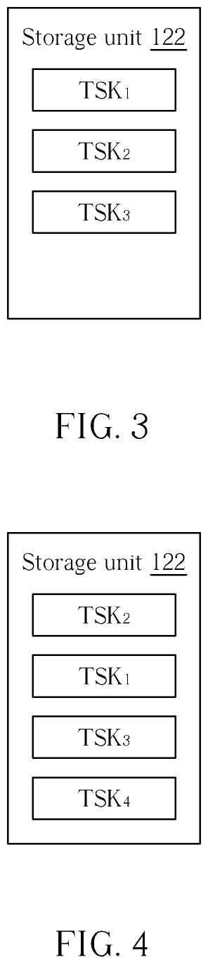

FIG. 3 shows the task instruction set stored in the internal storage unit 122 corresponding to the operation instruction INS₁ according to a scheduling algorithm. In FIG. 3, when the microcontroller 120 receives the operation instruction INS₁, the microcontroller 120 may issue the task instructions TSK₁, TSK₂, and TSK₃ sequentially as indicated by the task instruction set stored in the internal storage unit 122.

For example, the task instruction TSK₁ may imply to sense the read current, and task instructions TSK₂ and TSK₃ may imply to transfer the corresponding data respectively in the page buffer.

In this case, the order of the task instructions to be issued can be easily adjusted by updating the task instruction set stored in the storage unit 122. For example, FIG. 4 shows the task instruction set stored in the internal storage unit 122 corresponding to the operation instruction INS₁ according to the updated scheduling algorithm. In FIG. 4, when the microcontroller 120 receives the operation instruction INS₁, the microcontroller 120 will issue the task instructions TSK₂, TSK₁, TSK₃ and TSK₄ sequentially as indicated by the task instruction set stored in the internal storage unit 122.

That is, the order of the task instructions and the task instructions to be executed can be changed easily by updating the task instruction set stored in the storage unit 122 according to the desired scheduling algorithm. Therefore, the scheduling algorithm can be updated during the development of the memory control system 100, thereby improving the flexibility.

Furthermore, in some embodiments, the sequence processing unit 130 can also be coupled to the memory interface circuit 110 directly. In this case, the memory interface circuit 110 can control the sequence processing unit 130 to access the memory device 100 directly in a test mode of the memory control system 100. This function can be useful during the development stage of the memory control system 100. For example, when the microcontroller 120 is stuck, the memory interface circuit 110 can bypass the microcontroller 120 and control the sequence processing unit 130 directly to locate the issue for debugging. Also, this function can be convenient when testing a new algorithm.

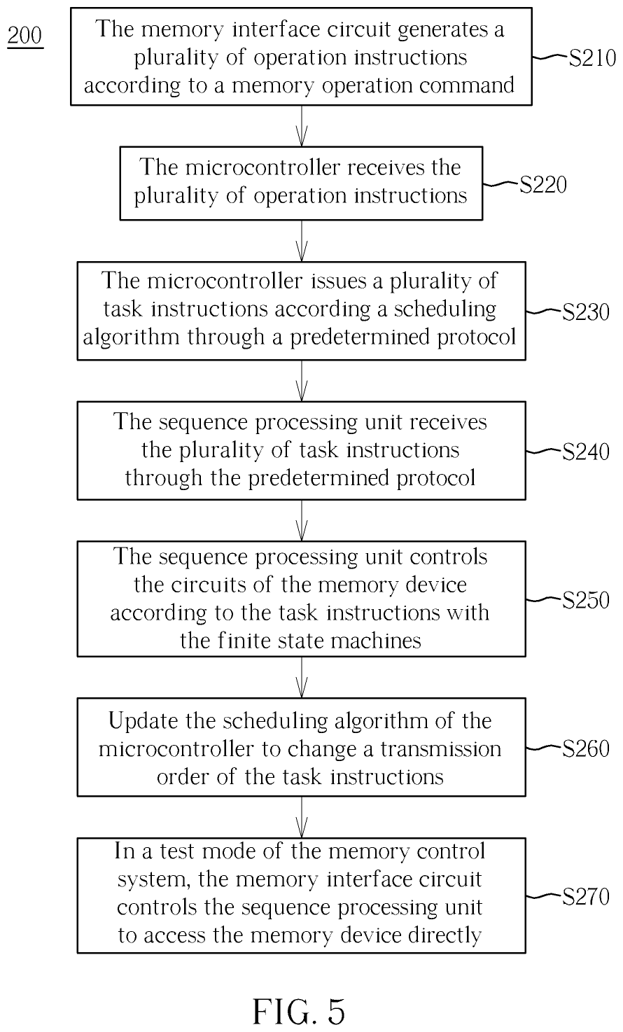

FIG. 5 shows a method 200 for operating the memory control system 100 according to one embodiment of the present invention. The method 200 includes steps S210 to S270.

S210: the memory interface circuit 110 generates a plurality of operation instructions INS₁ to INS_{X} according to a memory operation command OC1;

S220: the microcontroller 120 receives the plurality of operation instructions INS₁ to INS_{X};

S230: the microcontroller 120 issues a plurality of task instructions TSK₁ to TSK_{Y} according a scheduling algorithm through a predetermined protocol;

S240: the sequence processing unit 130 receives the plurality of task instructions TSK₁ to TSK_{Y} through the predetermined protocol;

S250: the sequence processing unit 130 controls the circuits of the memory device M1 according to the task instructions TSK₁ to TSK_{Y} with the finite state machines FSM1 and FSM2;

S260: update the scheduling algorithm of the microcontroller 120 to change a transmission order of the task instructions TSK₁ to TSK_{Y}; and

S270: in a test mode of the memory control system 100, the memory interface circuit 110 controls the sequence processing unit 120 to access the memory device M1 directly.

In some embodiments, the memory interface circuit 110 and the microcontroller 120 may communicate through a standard bus protocol while the microcontroller 120 and the sequence processing unit 130 may communicate through a specifically defined communication protocol. For example, in steps S230 and S240, the sequence processing unit 130 may receive the task instructions TSK₁ to TSK_{Y} by following the timing diagram shown in FIG. 2. However, in some other embodiments, the microcontroller 120 and the sequence processing unit 130 may communicate with other protocols according to the system requirement.

In summary, the memory control system and the method for operating the memory control system can control the memory device with the sequence processing unit of the memory control system. Since the sequence processing unit is finite state machine based, the control of the memory device can be simplified with higher utilization ratio and higher performance. Furthermore, since the memory control system also adopts a microcontroller to schedule the tasks, the scheduling algorithm can be updated flexibly by updating the instruction sets stored in the internal storage unit of the microcontroller, thereby improving the efficiency of development.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory control system comprising:
a memory interface circuit configured to receive a memory operation command and generate a plurality of operation instructions according to the memory operation command;
a microcontroller coupled to the memory interface circuit, and configured to receive the plurality of operation instructions and generate a plurality of task instructions according a scheduling algorithm through a predetermined protocol; and
a sequence processing unit coupled to the microcontroller, comprising at least one finite state machine, and configured to receive the plurality of task instructions through the predetermined protocol, and control a plurality of circuits of a memory device according to the plurality of task instructions with the at least one finite state machine.

2. The memory control system of claim 1, wherein:
the memory interface circuit and the microcontroller communicate through a standard bus protocol.

3. The memory control system of claim 1, wherein:
the sequence processing unit further comprises a load pin and an operation instruction pin; and
the sequence processing unit receives a task instruction when a voltage of the load pin is pulled high by the microcontroller.

4. The memory control system of claim 3, wherein:
the sequence processing unit further comprises a completion pin; and
when the task instruction has been performed, the sequence processing unit raises a voltage of the completion pin to notify the microcontroller.

5. The memory control system of claim 1, wherein the memory device is a non-volatile memory (NVM).

6. The memory control system of claim 1, wherein:
the plurality of circuits of the memory device comprises a charge pump, a power regulator, an address decoder, and/or a sense amplifier.

7. The memory control system of claim 1, wherein:
the microcontroller is further configured to update the scheduling algorithm to change an order of the plurality of task instructions.

8. The memory control system of claim 1, wherein:
the sequence processing unit is further coupled to the memory interface circuit; and
in a test mode of the memory control system, the memory interface circuit controls the sequence processing unit to access the memory device directly.

9. The memory control system of claim 1, wherein the memory interface circuit, the microcontroller, and the sequence processing unit are disposed in a same chip.

10. A method for operating a memory control system, the memory control system comprising a memory interface circuit, a microcontroller, and a sequence processing unit comprising at least one finite state machine, the method comprising:
the memory interface circuit generating a plurality of operation instructions according to a memory operation command;
the microcontroller receiving the plurality of operation instructions;
the microcontroller issuing a plurality of task instructions according a scheduling algorithm through a predetermined protocol;
the sequence processing unit receiving the plurality of task instructions through the predetermined protocol; and
the sequence processing unit controlling a plurality of circuits of a memory device according to the plurality of task instructions with the at least one finite state machine.

11. The method of claim 10, wherein:
the memory interface circuit and the microcontroller communicate through a standard bus protocol.

12. The method of claim 10, wherein the sequence processing unit further comprises a load pin and an operation instruction pin, and the method further comprises:
the microcontroller raising a voltage of the load pin; and
the sequence processing unit receiving a task instruction when the voltage of the load pin is pulled high.

13. The method of claim 12, wherein the sequence processing unit further comprises a completion pin, and the method further comprises:
when the task instruction has been performed, the sequence processing unit raising a voltage of the completion pin to notify the microcontroller.

14. The method of claim 10, wherein:
the plurality of circuits of the memory device comprises a charge pump, a power regulator, an address decoder, and/or a sense amplifier.

15. The method of claim 10, further comprising:
updating the scheduling algorithm of the microcontroller to change an order of the plurality of task instructions.

16. The method of claim 10, further comprising:
in a test mode of the memory control system, the memory interface circuit controlling the sequence processing unit to access the memory device directly.
